(19) United States
(12) Patent Application Publication
(10) Pub. No.: US 2025/0084946 A1
(43) Pub. Date: Mar. 13, 2025

(54) SEWER CLEANOUT CAP AND METHODS

(71) Applicants: Matthew Treado, Marquette, MI (US); Brian Patrick Janowski, Marquette, MI (US)

(72) Inventors: Matthew Treado, Marquette, MI (US); Brian Patrick Janowski, Marquette, MI (US)

(21) Appl. No.: 18/882,490

(22) Filed: Sep. 11, 2024

Related U.S. Application Data
(60) Provisional application No. 63/623,724, filed on Jan. 22, 2024.
(60) Provisional application No. 63/537,667, filed on Sep. 11, 2023.

(51) Int. Cl. F16L 55/115; E03F 3/04

(52) U.S. Cl. CPC F16L 55/1152; E03F 3/04

(57) ABSTRACT

A sewer cleanout cap characterized by reliable and rapid location underground thereby eliminating time wasted attempting to locate, dig for, repair, or replace standard cleanout caps. The cleanout cap comprises a generally disc shaped threaded cap body having a distal face and a central axis with a drive block extending proximally from a proximal face of the cap body. A first recess can extend into the cap body from the distal face, and a second recess can extend from the distal face into the drive block. A first magnet is generally aligned with the first axis and is fixed and sometimes sealed within the sewer cleanout cap. First magnet fixation approaches include securing the first magnet in a non-corrosive housing, molding the magnet into the cap, securing within in a first recess using friction or adhesives, securing it to a post, or securing the first magnet within deflectable prongs.

### CROSS REFERENCE TO RELATED APPLICATIONS

This is a Continuation-In-Part Patent Application of Non-Provisional patent application Ser. No. 17/748,010 filed May 18, 2022 which claims benefit of Provisional Patent Application No. 63/109,121 filed May 18, 2021. This instant application also claims the benefit of Provisional Patent Application No. 63/623,724 filed Jan. 22, 2024 and Provisional Patent Application No. 63/537,667 filed Sep. 11, 2023. The entire disclosures of each of these applications are hereby incorporated by reference and relied upon.

### BACKGROUND OF THE INVENTION

### Field of the Invention

The invention relates generally to sewer cleanout caps, and more particularly to sewer cleanout caps that have properties making them easy to locate by sensing equipment.

### Description of Related Art

Attempts have been made by some to create a locatable sewer cleanout cap by duct taping a magnet on the outside of a sewer cap. This system often fails due to a variety of reasons including: decomposition of the tape and the magnet falling away from the sewer cap, exposure of the magnet to shovels and other tools that can damage the magnet and/or knock it off the sewer cap, and loss of magnetic strength due to magnet corrosion since the magnets utilized commonly corrode when exposed to moisture. One of the primary goals of using a locatable sewer cap is reduction in time spent locating a sewer cap buried underground. Attempting to locate sewer caps solely by maps typically results in needless digging until the cap is located. Each week, hours can be lost attempting to locate a sewer cleanout cap underground. Magnets that fall off, are knocked off, are ineffective due to corrosion, or damaged during the location process, again results in extensive wasted time locating, repairing, or replacing the cap.

Panella (U.S. Pat. No. 5,038,829) teaches a sewer line clean out unit comprising a magnet in the upper surface of the cover at a perimeter edge as illustrated in FIG. 18 of Panella. Panella also discloses a magnet secured to an upper surface of a disc shaped cap where in the upper surface appears offset from a centralized drive surface. This offset placement results in inaccuracy when attempting to find the center drive axis of the sewer cleanout cap thus causing the user to typically dig a larger perimeter hole than necessary. Argonics® Corporation discloses on their website a sewer seal cleanout access cover made of polyurethane with a magnet embedded in the middle of the polyurethane cover. The cover is a press-in frictional design made of polyurethane directed primarily to vertically orientated sewer pipes. This cover lacks threads and has limited ability to seal non-vertical pipes. Removal of the cover is by use of a screwdriver to wedge the cover out of the pipe similar to removing a cover to a paint can. Furthermore, the use of polyurethane is an expensive choice of material that is beyond the budgets of many users and can have varying stiffness depending on the ambient temperature.

What is needed is a low cost externally threaded sewer cleanout cap preferably made of a hard polymer that integrates a generally centrally located magnet that is protected from corrosion and external tools for reliable and rapid location when performing underground sewer work.

### SUMMARY OF THE INVENTION

Disclosed herein are embodiments of a polymer sewer cleanout cap that integrates magnetic materials within the sewer cap near its central axis thereby assisting with locating sewer cleanouts.

In one form, a sewer cleanout cap comprises a disc shaped cap body.

In one form, the disc shaped cap body comprises a substantially flat proximal face that is accessible when in an operable configuration wherein the sewer cap is threaded into a sewer pipe. In a removed configuration, the sewer cap is removed from a sewer pipe.

In one form, the disc shaped cap body comprises a substantially flat distal face opposite the proximal face. The distal face faces the inside of the sewer pipe when threaded on the sewer pipe.

In one form, the disc shaped cap body comprises a circular external radial wall around a perimeter of the disc shaped cap body.

In one form, radial threads are inscribed in the external radial wall and operable for threaded cooperation with threads within a sewer pipe for sealing the sewer pipe using the sewer cleanout cap.

In one form, extending proximally from the cap body is a drive block operable for rotatably driving the sewer cleanout cap with a wrench.

In one form, the drive block comprises a drive block face spaced proximally from the proximal face.

In one form, a plurality of lateral drive flats extend between the proximal face and proximal drive block face.

In one form, the drive block comprises four lateral drive flats defining a substantially square drive block. In other forms, additional lateral drive flats can define drive blocks of other shapes such as hexagonal.

In one form, the distal face is substantially flat extending across to all ends of the external radial wall.

In one form, a first recess extends from the distal face at least partially into the cap body.

In one form, the first recess is defined by a first radial wall spaced inward from the external radial wall.

In one form, the first radial wall defines a circle.

In one form, a first recess face is inset proximally from the distal face.

In one form, the first recess face and the first radial wall define the first recess.

In one form, a second recess extends proximally from at least one of the distal face and first recess face at least partially into said drive block.

In one form, the second recess comprises a second radial wall spaced inward from the lateral drive flats.

In one form, the second recess is substantially square although it can be defined by other profiles such as hexagonal.

In one form, the second recess terminates at a second recess face.

In one form, the second recess is defined by the plurality of second radial walls and second recess face.

In one form, a sewer cap comprises a first magnet.

In one form, the first magnet is enclosed in a magnet housing.

In one form, the first magnet is enclosed in a magnet housing that is a non-corrosive housing.

In one form, the non-corrosive housing comprises one or more layers of nickel coating (i.e. 3) on the external surfaces of the magnet.

In one form, the non-corrosive housing comprises a 3 layer nickel-copper-nickel plating on the external surfaces of the magnet.

In one form, the non-corrosive housing comprises a capture boss having a first magnet recess for storing the first magnet, and a brim wall extending radially from the capture boss. A face of the brim wall is secured to a second recess face of the cap body using sealants and/or adhesives.

In one form, the non-corrosive housing, sealant/adhesive, and first magnet are offered as a kit for end users or suppliers of sewer caps to transform them to magnetically locatable sewer caps.

In one form, the first magnet is of sufficient strength to be sensed by a locating device when buried in soil 6-18 inches deep.

In one form, the non-corrosive housing is in the form of an epoxy coating or other sealant.

In one form, the non-corrosive housing is in the form of a plastic such as ABS or silicone.

In one form, the non-corrosive housing is in the form of an envelope.

In one form, the non-corrosive housing also insulates the first magnet from high temperature thereby allowing the first magnet to be molded within the sewer cap without diminishing the strength of the magnet due to heat.

In one form, the non-corrosive housing is between 0.2 mm and 2 mm thick although other thicknesses can be used.

In one form, the first magnet is a neodymium magnet.

In one form, the first magnet is a high temperature neodymium magnet able to withstand temperatures up to 150 degrees Celsius.

In one form, the first magnet is secured to a sewer cap using adhesives.

In one form, the first magnet comprises a substantially flat first magnet face.

In one form, the first magnet comprises a substantially flat third magnet face opposite the first magnet face.

In one form, the first magnet comprises a radial second magnet face extending between the first magnet face and third magnet face.

In one form, a first magnet recess is defined by one or more magnet recess faces extending into the drive block.

In one form, a first magnet recess extends distally from the proximal drive block face.

In one form, a first magnet recess extends laterally from a lateral drive flat into the drive block.

In one form, the first magnet recess comprises at least one of a: first recess retainer, a second recess retainer, and a third recess retainer.

In one form, the recess retainers partially obstruct the first magnet recess.

In one form, the recess retainers are spaced about the opening to the first magnet recess. In one form, the first magnet is seated in the first magnet recess.

In one form, the first magnet is sized and shaped for friction fit into the first magnet recess.

In one form, the first magnet is secured in the first magnet recess by the recess retainers.

In one form, the first magnet is molded within the drive block during forming of the sewer cap of a polymer such as PVC, polypropylene, CPVC, and ABS.

In one form, the first magnet is enclosed in a non-corrosive housing before molding in a sewer cap.

In one form, a heated iron is used to heat a polymer section of a sewer cap to a melting temperature and is removed before inserting a first magnet into the melted polymer to secure it therein once the material cools.

In one form, a first magnet is secured to the cap body by one or more of adhesives such as epoxy, glue, and tape.

In one form, a first magnet is secured to the second recess face.

In one form, the first magnet is secured substantially aligned with central axis A. In one form, the sewer cap is absent a first recess and a second recess.

In one form, the first magnet is secured to a sewer cap using a fastener such as a screw.

In one form, the first magnet is housed within a first magnet recess within a capture boss extending from the second recess face on the inside of the sewer cap.

In one form, the first magnet is secured within the first magnet recess with a layer of adhesives/sealants.

In one form, the first magnet recess opens to an outside surface of the sewer cap.

In one form, the first magnet recess opens to an inside surface of the sewer cap.

In one form, the first magnet is in the form of a ring that is pressed over and retained by deflectable prongs on the inside of the sewer cap.

In one form, the first magnet is secured at a central axis A of the threaded sewer cap.

In one form, the first magnet is secured by pressed fit over a elongate capture boss extending from the inside of the sewer cap.

In one form, the first magnet is secured by a spring clip or pin that engages with an elongate capture boss extending from the inside of the sewer cap.

In one form, the first magnet is secured by a lock fastener that threads into a capture boss and/or second recess face of a sewer cap.

In one form, the first magnet can be in the form of a square bar, a star, a sphere, a disc, a cylinder, a block/cube, stepped blocks/discs, rings, rings with countersink, stud mounted, stud screwed into recess, magnet sticks to stud.

In one form, the sewer cap comprises an identifier to indicate it contains a locatable magnet.

In one form, the identifier is positioned within the proximal drive block face.

In one form, the identifier is positioned within a lateral drive flat.

In one form, the identifier is positioned on a proximal face.

In one form, the identifier is in the form of a raised or recessed symbol in an exposed surface of the cap such as the letter ‘M’ when the cap is in an operable configuration.

In one form, the identifier is in the form of a distinctive color for quick identification. For example, a first magnet can be sealed in first recess using a marine grade caulk or sealant that is in a contrasting color to the surrounding soil. The contrasting color (i.e. red) is highly visible next to black dirt. Likewise, this identification makes identification of a magnetic sewer cap vs a non-magnetic sewer caps easy when faced with an array of sewer caps stored in bulk.

In one form, the magnetic sewer cap is manufactured from a dyed polymer for easy identification. For example, a red dyed PVC is used as an alternative to standard white PVC.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1A depicts an exploded perspective view of the sewer cleanout cap of FIG. 1B;

FIG. 1B depicts a perspective view of a sewer cleanout cap;

FIG. 1C depicts an opposed perspective view of the sewer cleanout cap of FIG. 1B;

FIG. 2A depicts an exploded perspective view of the sewer cleanout cap of FIG. 2B;

FIG. 2B depicts a perspective view of a sewer cleanout cap;

FIG. 3A depicts an exploded perspective view of the sewer cleanout cap of FIG. 3B;

FIG. 3B depicts a perspective view of a sewer cleanout cap;

FIG. 4A depicts a cross-sectional perspective view of the sewer cleanout cap of FIG. 4B;

FIG. 4B depicts a perspective view of a sewer cleanout cap;

FIG. 5 depicts a perspective view of a sewer cleanout cap;

FIG. 6A depicts an exploded perspective view of the sewer cleanout cap of FIG. 6B;

FIG. 6B depicts a perspective view of a sewer cleanout cap;

FIG. 7A depicts an exploded perspective view of the sewer cleanout cap of FIG. 7B;

FIG. 7B depicts a perspective view of a sewer cleanout cap;

FIG. 7C depicts a cross-sectional perspective view of the sewer cleanout cap of FIG. 7B.

FIG. 8 depicts a perspective view of a sewer cleanout cap;

FIG. 9 depicts a perspective view of a sewer cleanout cap;

FIG. 10 depicts an exploded perspective view of a sewer cleanout cap having a fastener securing a ring magnet therein;

FIG. 11 depicts a perspective view of the sewer cleanout cap of FIG. 10;

FIG. 12 depicts a perspective view of a sewer cleanout cap with an identifier located on a proximal drive block face;

FIG. 13 depicts a perspective view of a non-corrosive housing for containing a magnet therein;

FIG. 14 depicts just some of the various magnet shapes that can be used in a sewer cleanout cap;

FIG. 15 depicts an exploded perspective view of a sewer cleanout cap;

FIG. 16 depicts an opposed perspective view of a non-corrosive housing used in the sewer cap of FIG. 15;

FIG. 17 depicts a perspective view of a sewer cleanout cap;

FIG. 18 depicts an exploded opposed perspective view of the sewer cleanout cap of FIG. 17;

FIG. 19 depicts an opposed perspective view of the sewer cleanout cap of FIG. 17;

FIG. 20 depicts an exploded perspective view of a sewer cleanout cap;

FIG. 21 depicts an exploded perspective view of the sewer cleanout cap of FIG. 22;

FIG. 22 depicts a perspective view of a sewer cleanout cap;

FIG. 23 depicts an exploded perspective view of a sewer cleanout cap with a closeup view of the deflectable prongs depicted above;

FIG. 24 depicts a perspective view of a sewer cleanout cap;

FIG. 25 depicts and exploded perspective view of the sewer cleanout cap of FIG. 24;

FIG. 26 depicts a perspective view of a sewer cleanout cap;

FIG. 27 depicts an exploded perspective view of the sewer cleanout cap of FIG. 26;

FIG. 28 depicts a perspective view of a sewer cleanout cap;

FIG. 29 depicts an exploded perspective view of the sewer cleanout cap of FIG. 28.

### DETAILED DESCRIPTION OF SELECTED EMBODIMENTS OF THE INVENTION

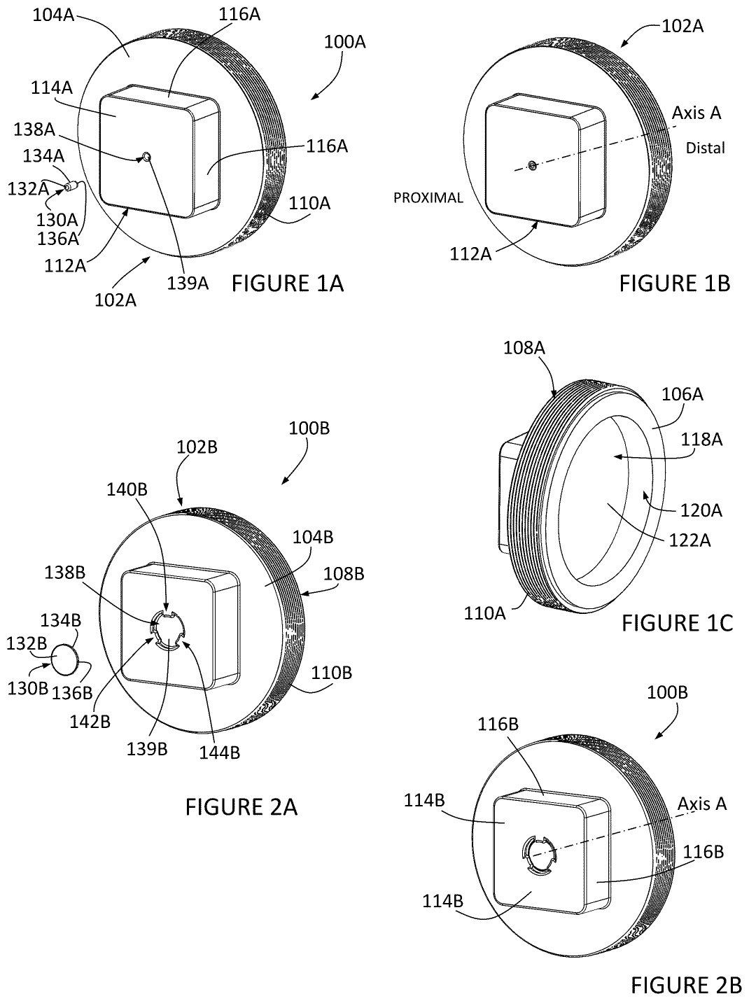

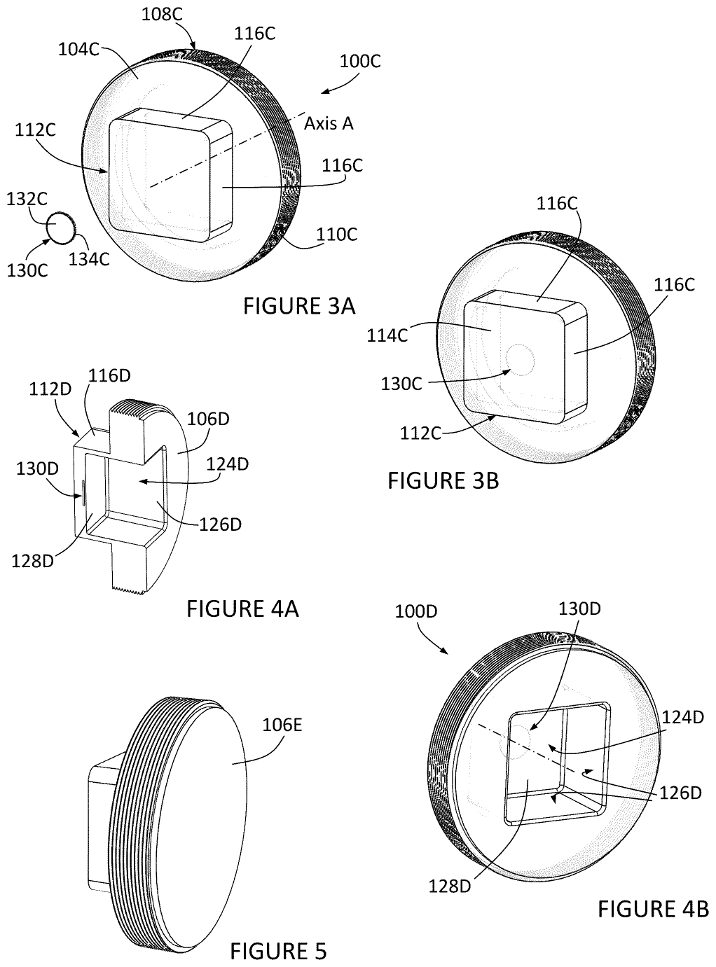

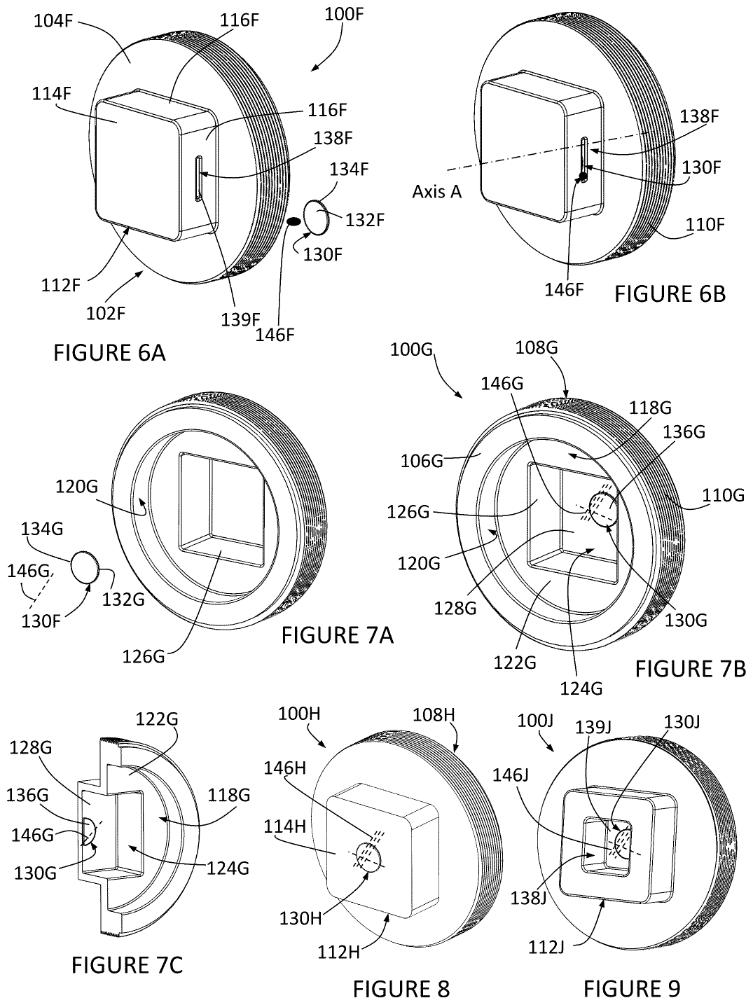

Select embodiments of the invention will now be described with reference to the Figures. Like numerals indicate like or corresponding elements throughout the several views and wherein various embodiments are separated by letters (i.e. 100A, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes, or which is essential to practicing the invention described herein. Some of the views illustrated are exploded views whereby: FIG. 1A is an exploded view of FIG. 1B, FIG. 2A is an exploded view of FIG. 2B, FIG. 3A is an exploded view of FIG. 3B, FIG. 6A is an exploded view of FIG. 6B, and FIG. 7A is an exploded view of FIG. 7B, etc.

FIG. 1A-1C illustrates a sewer cleanout cap according to one embodiment of the invention. The sewer cleanout cap 100A comprises a disc shaped cap body 102A. The disc shaped cap body 102A comprises a proximal face 104A that is accessible when in an operable configuration wherein the sewer cleanout cap is threaded into a sewer pipe, and a distal face 106A opposite the proximal face. In most embodiments, the proximal and distal faces are substantially flat, however, those skilled in the art will recognize other non-flat configurations such as a sloped face or faceted face can be assumed. The distal face faces the inside of the sewer pipe when threaded on a sewer pipe and this is known as the operable configuration versus a removed configuration when the sewer cleanout cap is removed from a sewer pipe. As illustrated here, the cap body 102A comprises a circular external radial wall 108A extending around a perimeter of the cap body with radial threads 110A inscribed in the external radial wall 108A and operable for threaded cooperation with threads within a sewer pipe for sealing the sewer pipe using the sewer cleanout cap. In some forms the cap is substantially a hard plastic such as PVC, ABS or other similar material known in the art.

Extending proximally from the cap body 102A is a drive block 112A operable for rotatably driving the sewer cleanout cap 100A with a wrench. The drive block 112A comprises a proximal drive block face 114A generally parallel and spaced proximally from the proximal face. A plurality of lateral drive flats 116A extend between the proximal face 104A and proximal drive block face 114A. The drive block 112A comprises four lateral drive flats 116A defining a substantially square drive block, however, in other embodiments, more lateral drive flats may be present defining a hex drive block for example.

The distal face 106A is spaced distally from the proximal face 104A and is substantially flat extending across to the external radial wall 108A. In this embodiment, although optional in some embodiments, a first recess 118A extends from the distal face 106A at least partially into the cap body 102A. The first recess 118A is defined by a first radial wall 120A spaced inward from the external radial wall 108A. A first recess face 122A is inset proximally from the distal face 106A. Together, the first recess face 122A and the first radial wall 120A define the first recess 118A.

In other embodiments such as illustrated in FIG. 4B and sectional view of FIG. 4A and although optional, a second recess 124D extends proximally from at least one of the distal face 106D and first recess face (i.e. 122G) at least partially into said drive block 112D. As further illustrated in FIG. 4B, the second recess 124D comprises second radial walls 126D spaced inward towards central axis A from the lateral drive flats 116D. As illustrated here, the second recess 124D terminates at a second recess face 128D. The second recess 124D is defined by the plurality of second radial walls 126D and second recess face 128D. In some embodiments, the sewer cleanout caps disclosed herein can be absent a first recess and/or a second recess as illustrated in the embodiment of FIG. 5. (In FIG. 5 the first magnet is molded into the drive block).

Embodiments of a sewer cleanout cap herein further comprises a first magnet. The first magnet can assume any variety of shapes, most commonly the first magnet 130A comprises a substantially flat first magnet face 132A and a substantially flat third magnet face 136A opposite the first magnet face. A radial second magnet face 134A extends between the first magnet face 132A and third magnet face 136A. Some examples of various magnets are illustrated in the figures such as 130A in FIG. 1A, and 130B in FIG. 2A. One skilled in the art will recognize that the first magnet can assume a variety of profiles as can the first magnet recess where it is seated. For example, the magnet can have a second magnet face that is non-circular such as square or hexagonal shape and others such as those depicted in FIG. 14.

A first magnet recess 138A is defined by one or more magnet recess faces 139A. In the FIG. 1A embodiment, the first magnet 130A recess extends distally from the proximal drive block face 114A into the drive block 112A. As illustrated in other embodiments such as FIG. 6A, the first magnet recess 138F extends laterally from a lateral drive flat 116F into the drive block 112F. The first magnet recess in alternative embodiments can be recessed into the second recess face such as illustrated with 128D.

As illustrated in the FIG. 2A-2B embodiment, the first magnet recess comprises at least one of a: first recess retainer 140B, a second recess retainer 142B, and an optional third recess retainer 144B whereby the recess retainers partially obstruct the first magnet recess 138B. As seen here, in an operable configuration (FIG. 2B), the first magnet 130B is seated in the first magnet recess 138B and the first magnet 130B is sized and shaped for seating within the first magnet recess 138B (i.e. circular magnet in circular recess) and held in position with one or more recess retainer. In other embodiments such as illustrated in FIG. 1A, the first magnet 130A is operable for friction fit into first magnet recess 138A. This can include heating at least the first magnet recess area before inserting the first magnet into the more pliable material. Alternatively, the first magnet can be fixed into the magnet recess by using a bonding material such as an epoxy or other adhesive/bonding/sealant agent which can be in contact with one or more surfaces of the first magnet or block the first magnet recess or both. As recognized by those skilled in the art, individual features illustrated in the Figures can be combined in unique combinations for sewer cleanout caps consistent with the intentions of this disclosure.

As illustrated in the FIGS. 3A and 3B embodiment, the first magnet 130C is molded within the drive block 112C during forming operations of the sewer cap of a polymer such as PVC. In other embodiments, a first magnet is secured to or blocked from release from the cap body by one or more of adhesives/bonding agent/sealant such as epoxy, glue, and tape. An example of this is illustrated in FIG. 6B whereby adhesive 146F blocks first magnet 130F from escaping the first magnet recess 138F and can be used to seal it against outside elements leading to corrosion. Similarly, as shown in FIG. 7B, an adhesive 146G can be used to bond the first magnet to a surface of the sewer cleanout cap or otherwise bury the first magnet within the adhesive. Here, the first magnet 130G is secured to the second recess face 128G. Similar to the embodiment of FIG. 7B, in alternative embodiments, an adhesive can be used to block first magnet 130B in first magnet recess 138B in the absence of the recess retainers or to adhere a first magnet 130H to the proximal drive block face 114H (preferably aligned with axis A) in the absence of a first magnet recess such as illustrated in FIG. 8. FIG. 9 illustrates a first magnet 130J secured to a magnet recess face 139J in a first magnet recess 138J that is oversized and/or having a different profile than the first magnet (i.e. a square first magnet recess and round first magnet). Again, an adhesive 146J or other similar agent can be used to secure the first magnet 130J generally at the central axis.

Note in preferred embodiments, the first magnet is substantially aligned with central axis A extending central through the cap body. This positioning creates more accurate sewer cleanout cap locating missions and therefore reduced digging to find the sewer cleanout cap when buried under dirt in a yard. Reduced digging of course equates to reduced labor costs.

As depicted in the FIG. 13 embodiment, the first magnet 130L can be enclosed in a non-corrosive housing. In this case, the non-corrosive housing 164L is in the form of an envelope sized larger than the magnet comprising housing walls 167L that define the enclosure. A housing entrance 165L leads into a housing cavity 166L configured in size and shape to house the first magnet therein. In some embodiments, the non-corrosive housing is in the form of a coating 168L on the exterior surfaces of the magnet. The coating 168L can be for example, one or more layers of nickel coating (i.e. 3), and/or a 3-layer nickel-copper-nickel plating on the external surfaces of the magnet. Alternatively, the non-corrosive housing can be in the form of a polymer and/or epoxy coating or other sealant. Examples of polymers can include but are not limited to ABS or silicone.

The non-corrosive housing 164L (i.e. FIG. 13) can be used in some cases to insulate the first magnet 130L from high temperature thereby allowing the first magnet to be molded within the sewer cap without diminishing the strength of the magnet due to heat to form the sewer cleanout cap depicted in FIG. 3B. It should be noted that more than one type of non-corrosive housing can be used. For example, the magnet can be both coated and enclosed in an envelope form of housing. In some embodiments, the non-corrosive housing is between 0.2 mm and 2 mm thick although other thicknesses can be used.

In some embodiments, the first magnet is a neodymium magnet. In some cases, the first magnet is a high temperature neodymium magnet able to withstand temperatures up to 150 degrees Celsius. In some embodiments, a heated iron is used to heat a polymer section of a sewer cap to a melting temperature and is removed before inserting a first magnet into the melted polymer to secure it therein once the material cools.

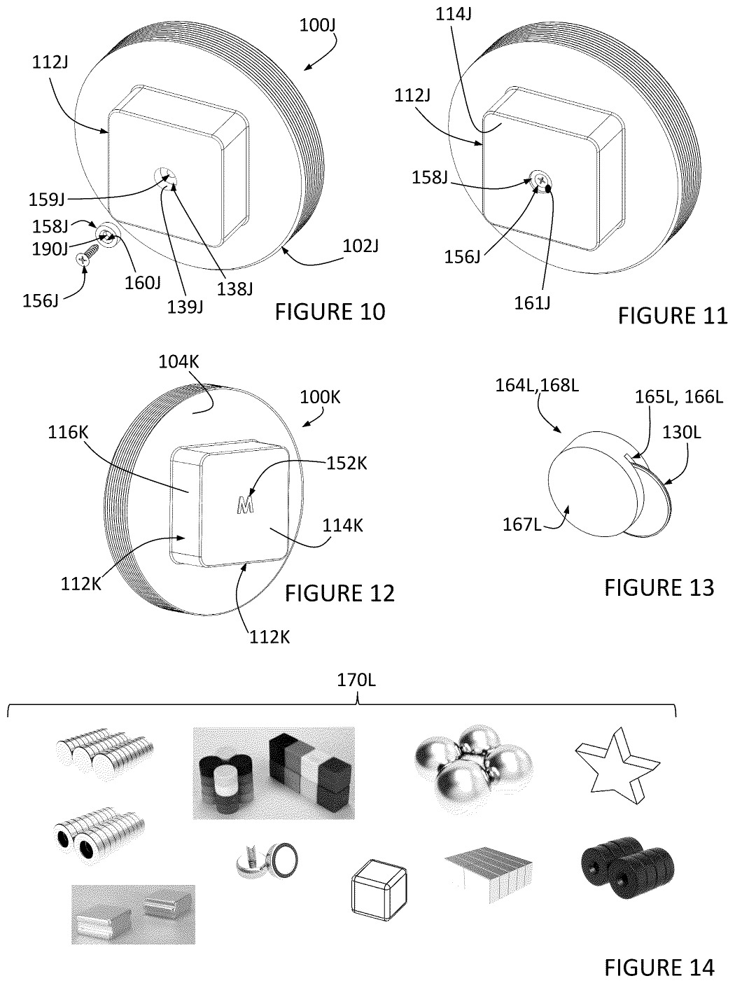

As depicted in FIGS. 10-11 in yet another embodiment, the first magnet is secured to a sewer cap using a magnet fastener 156J such as a screw. A flat head screw is used here which is preferably a non-corrosive or low corrosion screw (i.e. zinc coated, stainless steel). In this embodiment, first magnet recess 138J defined by magnet recess face 139J is sized and shaped (i.e. rounded depression) to house a first magnet therein. A magnet fastening hole 159J (which can be threaded) extends into the cap body 102J for receiving the threaded portion of magnet fastener 156J. In some embodiments, magnet fastener 156J is self-threading. In this case (FIG. 11), the first magnet is a ring magnet 158J that has a countersunk 160J magnet window 190J for passing the shank of the magnet fastener therethrough. FIG. 11 depicts the magnet secured in the first magnet recess 138J and in this case is sealed with a sealant 161J to further protect the magnet from corrosion. It is preferred if the magnet and screw are sub surface from proximal drive block face 114J to prevent damage from tools such as a shovel. Several of the embodiments disclosed are configured so as to shield the magnet from tool impact.

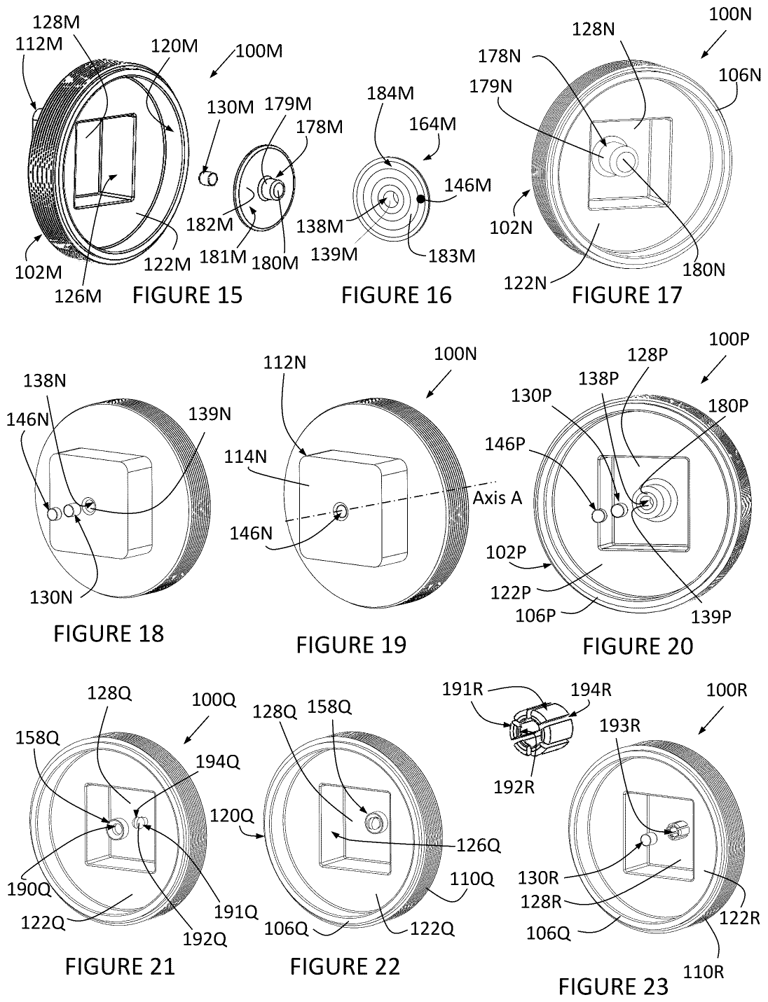

As depicted in FIGS. 15-16, the first magnet can be housed in a non-corrosive housing 164M. In this embodiment, the non-corrosive housing comprises a capture boss 178M which here is in the form of a cylinder but can assume other shapes. The capture boss 178M terminates in a distal boss surface 180M and has a radial surface 179M that encircles the capture boss. At the base of the capture boss, an optional brim wall 181M extends radially outward and is defined by a first brim face 182M with an opposed distal boss face 183M. Here the non-corrosive housing resembles a sombrero although in alternative embodiments the brim wall can be absent and the proximal end of the non-corrosive housing is directly secured to the second recess face of the cap body. The distal boss face 183M can contain one or more radial sealant grooves 184M operable to house a bead of adhesive/sealant. Once sealant/adhesive 146M is applied, the non-corrosive housing (with magnet housed in a first magnet recess 138M defined by magnet recess faces 139M in the capture boss), is secured against second recess face 128M and allowed to cure. Once cured, the first magnet is sealed and secured within non-corrosive housing 164M on sewer cap body 102 and ready for use. Brim wall 181M is preferably sized such that it is used to instantly center the first magnet 130M along axis A between surrounding second radial walls 126M.

Yet another embodiment is illustrated in FIGS. 17-19. In this embodiment, a capture boss 178N is molded within the sewer cap body 102N (along Axis A) protruding distally from the second recess face 128N. A first magnet recess 138N is molded into the cap body 102N and is accessible through proximal drive block face 114N (FIG. 18), or through distal boss surface 180P in the FIG. 20 embodiment. Again, magnet recess faces 139N, 139P define the first magnet recess 138N, 138P where the first magnet is housed. Friction fit or an adhesive/sealant 146N, 146P can be used to secure and seal the magnet in position within the first magnet recess.

FIG. 21-23 depict embodiments wherein a first magnet is secured by deflectable prongs. As noted in FIGS. 21-22, the deflectable prong 191Q extends along axis A from second recess face 128Q, and deflectable prong 191R extends from second recess face 128R as noted in FIG. 23. Retaining bosses 192Q, 192R extend from the deflectable prongs to secure the first magnet in position once the first magnet is pressed into position. In the case of FIGS. 21 and 22, the prongs deflect inwards and spring back outwards when the first magnet (ring magnet) is slid and secured in position. In the case of FIG. 23, the deflectable prongs deflect outwards as first magnet 130R is pushed into retaining cavity 193R and then secured by a retaining boss 192R. Deflection spaces 194Q, 194R, provide the space required for the deflection to occur. The deflection spaces are typically in the form of slots.

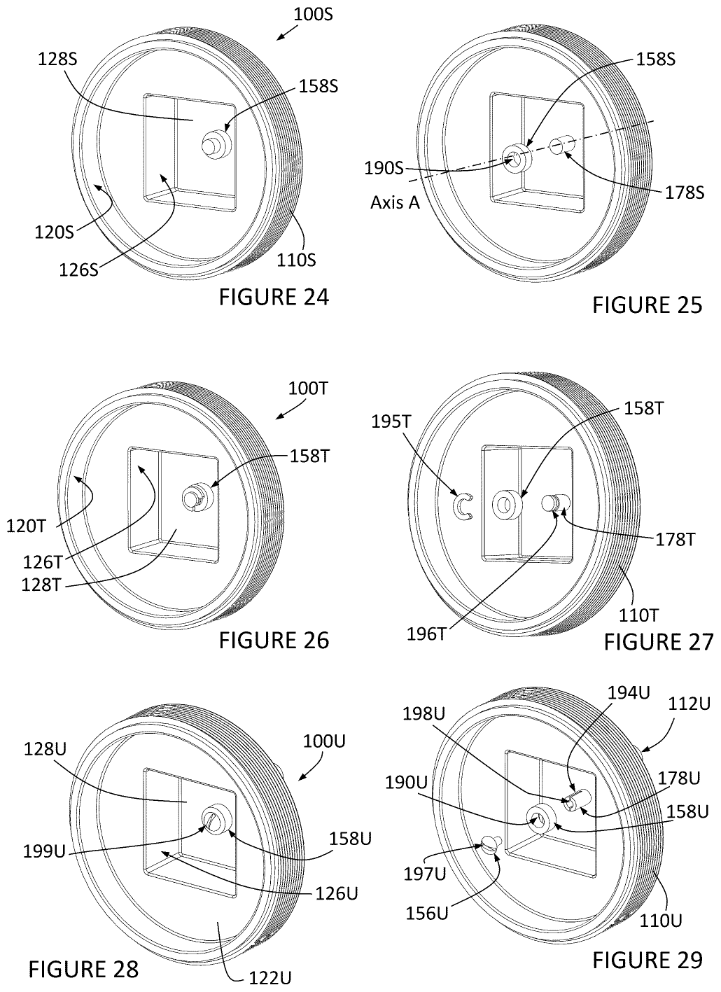

FIGS. 24-29 depict sewer cleanout caps (100S, 100T, 100U) also comprising a capture boss 178S, 178T, 178U that extends distally from the respective second recess face or in some embodiments from a first recess face when a second recess is absent. However, in the FIG. 24-29 embodiments, the capture boss does not house the first magnet within. Instead, the first magnet is in the form of a ring magnet 158S, 158T, 158U that is secured on the capture boss through magnet window 190S, 190T, 190U. In the embodiment of FIG. 24-25, the ring magnet is either threaded over the capture boss or simply pressed or twisted over it and held by friction or slight deformation. The post and/or magnet can be heated to reduce friction during insertion with the polymer of the capture boss rehardening when cooled.

FIG. 26-27 depicts a ring magnet 158T that is placed over the capture boss 178T and retained by a spring clip or pin 195T. A retainer groove 196T at a distal end of the capture boss 178T can be provided to seat the spring clip.

FIG. 28-29 depicts a ring magnet 18 secured to capture boss 178U by using a magnet fastener 156U extending through magnet window 190U of the ring magnet and into a retainer bore 198U within the capture boss. In some embodiments, a deflection space 194U is provided to expand the capture boss to further secure the magnet as the lock fastener 199U is advanced. In other embodiments, capture boss expands slightly as the lock fastener is driven without rotation. Drive head 197U secures the magnet from leaving the capture boss. In some embodiments, the magnet fastener 156U is in the form of a screw, however, it may assume other forms such as a rivet.

It should be noted that in alternative embodiments where the second recess face is absent, the capture boss can extend from the first recess face.

The magnets utilized in the sewer cleanout caps can have a wide variety of profiles. For example, various magnet shape variations 170L are depicted in FIG. 14. The first magnet can be, but not limited to the form of a square bar, a star, a sphere, a disc, a cylinder, a block/cube, stepped blocks/discs, rings, rings with countersink, stud mounted, stud screwed into recess, and magnet sticks to stud.

In some embodiments such as depicted in FIG. 12, the sewer cleanout cap 100K comprises an identifier 152K to indicate it contains a locatable magnet. In some embodiments, the identifier is positioned within or extends from the proximal drive block face 114K. Alternatively, the identifier can be placed elsewhere such as within a lateral drive flat 116K or on or within a proximal face 104K. As depicted in the Figure, the identifier is in the form of a raised or recessed symbol or word in an exposed surface of the cap such as the letter ‘M’ when the cap is in an operable configuration.

In some embodiments, the identifier 152K is in the form of a distinctive color for quick identification. For example, a first magnet can be sealed and covered in a first recess using a marine grade caulk or sealant 161J that is in a contrasting color to the surrounding soil. The contrasting color (i.e. red) is highly visible next to black dirt. Likewise, this identifier makes identification of a magnetic sewer cap vs a non-magnetic sewer caps easy when faced with an array of sewer caps stored in bulk. As yet another alternative, cap body 102 of a magnetic sewer cap is manufactured from a dyed polymer for easy identification. For example, a red dyed PVC is used as an alternative to standard white PVC.

For best function, the magnet of the sewer cleanout cap is of sufficient magnetic strength to be sensed by a locating device used above ground when the sewer cleanout cap is buried in soil 6-18 inches deep.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. The foregoing invention has been described in accordance with the relevant legal standards, thus the description is exemplary rather than limiting in nature. Variations and modifications to the disclosed embodiment may become apparent to those skilled in the art and fall within the scope of the invention.

1. A locatable sewer cleanout cap comprising:
a cap body;
said cap body being substantially disc shaped;
said cap body having a proximal face that is accessible when said sewer cleanout cap is in an operable configuration threaded into a sewer pipe;
said cap body having a distal face spaced distally from said proximal face;
said cap body having an external radial wall extending between said distal face and said proximal face;
said external radial wall inscribed about its perimeter with radial threads operable for mating with a threaded sewer pipe;
a drive block;
said drive block extending proximally from said proximal face;
said drive block having a proximal drive block face spaced proximally from said proximal face;
said drive block comprising a plurality of lateral drive flats encircling said drive block;
said drive flats extending perpendicular from said proximal face and extending between said proximal face and said drive block face;
said drive block and said cap body aligned along a common central axis;
a first magnet;
said first magnet secured to said sewer cleanout cap;
said first magnet aligned with said central axis; and,
a distal facing surface on at least one of or both of said cap body and said drive block.

2. The locatable sewer cleanout cap of claim 1 further comprising:
a first magnet recess;
said first magnet recess extending into said proximal drive block face;
a magnet fastening hole extending distally from said first magnet recess into said drive block;
said first magnet recess and said magnet fastening hole aligned with said central axis;
said first magnet being ring shaped;
said first magnet having a central magnet window;
said first magnet seated in said first magnet recess;
a magnet fastener; and,
wherein said magnet fastener extends through said first magnet window and is secured in said magnet fastening hole.

3. The locatable sewer cleanout cap of claim 1 further comprising:
an identifier;
said identifier positioned on said proximal drive block face to identify said locatable sewer cleanout cap as a locatable variety.

4. The locatable sewer cleanout cap of claim 1 wherein said first magnet is contained in a non-corrosive housing.

5. The locatable sewer cleanout cap of claim 4 wherein said non-corrosive housing is in the form of a coating.

6. The locatable sewer cleanout cap of claim 4 further comprising:
a non-corrosive housing in the form of a capture boss;
said capture boss comprising a distal boss surface facing distally;
said capture boss comprising a proximal boss surface facing proximally;
said capture boss comprising a first magnet recess extending into said capture boss through said proximal boss surface;
said first magnet seated in said first magnet recess; and,
wherein said capture boss and said first magnet are bonded to one of said distal facing surfaces.

7. The locatable sewer cleanout cap of claim 6 further comprising:
a brim wall;
said brim wall extending radially outward from said capture boss at a proximal end of said capture boss.

8. The locatable sewer cleanout cap of claim 7 further comprising:
wherein said brim wall comprises a radial sealant groove in said proximal boss surface for receiving a bonding agent.

9. A locatable sewer cleanout cap comprising:
a cap body;
said cap body being substantially disc shaped;
said cap body having a proximal face that is accessible when said sewer cleanout cap is in an operable configuration threaded into a sewer pipe;
said cap body having a distal face spaced distally from said proximal face;
said cap body having an external radial wall extending between said distal face and said proximal face;
said external radial wall inscribed about its perimeter with radial threads operable for mating with a threaded sewer pipe;
a drive block;
said drive block extending from said proximal face;
said drive block having a proximal drive block face spaced proximally from said proximal face;
said drive block comprising a plurality of lateral drive flats extending perpendicular from said proximal face and extending between said proximal face and said drive block face;
said drive block and said cap body aligned along a common central axis;
at least one of a distal facing first recess face in said cap body inset proximally from said distal face and spaced distally from said proximal face, and a distal facing second recess face in said drive block inset proximally from said distal face and spaced distally from said proximal drive block face;
a first magnet;
said first magnet secured to said sewer cleanout cap; and,
said first magnet aligned with said central axis.

10. The locatable sewer cleanout cap of claim 9 further comprising:
a capture boss aligned along said central axis extending distally from said first recess face or said second recess face;
a first magnet recess;
said first magnet recess extending from said proximal drive block face into said capture boss;
said first magnet seated in said first magnet recess;
at least one of an adhesive, bonding agent, and sealant; and,
wherein said at least one of an adhesive, bonding agent, and sealant is applied in said first magnet recess to seal said first magnet in said first magnet recess.

11. The locatable sewer cleanout cap of claim 9 further comprising:
a capture boss aligned along said central axis extending distally from said first recess face or second recess face;
a distal boss surface facing distally at the end of said capture boss;
a first magnet recess;
said first magnet recess extending from said distal boss face into said capture boss;
said first magnet seated in said first magnet recess;
at least one of an adhesive, bonding agent, and sealant; and,
wherein said at least one of an adhesive, bonding agent, and sealant is applied in said first magnet recess to seal said first magnet in said first magnet recess.

12. The locatable sewer cleanout cap of claim 9 further comprising:
one or more deflectable prongs;
said one or more deflectable prongs extending distally from at least one of said first recess face and said second recess face;
said first magnet in the form of a ring;
said first magnet having a central magnet window extending therethrough; and,
wherein said one or more deflectable prongs are pushed through said magnet window seating said first magnet on said deflectable prongs.

13. The locatable sewer cleanout cap of claim 9 further comprising:
a plurality of deflectable prongs;
said deflectable prongs extending distally from at least one of said first recess face and said second recess face;
said deflectable prong arranged in a circle defining a retaining cavity therein for housing said first magnet therein; and,
said first magnet seated within said retaining cavity.

14. The locatable sewer cleanout cap of claim 9 further comprising:
a capture boss;
said capture boss extending distally from at least one of said first recess face and said second recess face;
said first magnet in the form of a ring;
said first magnet having a central magnet window extending therethrough; and,
wherein said capture boss extends through said central magnet window thereby frictionally seating said first magnet on said capture boss.

15. The locatable sewer cleanout cap of claim 9 further comprising:
a capture boss;
said capture boss extending distally from at least one of said first recess face and said second recess face;
said capture boss comprising a retainer groove encircling said capture boss;
said first magnet in the form of a ring;
said first magnet having a central magnet window extending through said first magnet; and,
wherein said capture boss extends through said central magnet window seating said first magnet on said capture boss;
a spring clip; and,
wherein said spring clip is seated within said retainer groove thereby securing said first magnet on said capture boss.

16. The locatable sewer cleanout cap of claim 9 further comprising:
a capture boss;
said capture boss extending distally from at least one of said first recess face and said second recess face;
said capture boss comprising a retainer bore centered in said capture boss;
said first magnet in the form of a ring;
a magnet fastener;
said first magnet having a central magnet window extending through said first magnet; and,
said capture boss extending through said central magnet window seating said first magnet on said capture boss; and,
wherein said magnet fastener is seated within said retainer bore thereby securing said first magnet on said capture boss.

17. The locatable sewer cleanout cap of claim 9 further comprising:
a first radial wall encircling said cap body; and,
wherein said first radial wall and first recess face define a first recess.

18. The locatable sewer cleanout cap of claim 9 further comprising:
a second radial wall within said drive block spaced inward from said lateral drive flats; and,
wherein said second radial wall and said second recess face define a second recess.
